(19) United States
(12) Patent Application Publication
(10) Pub. No.: US 2012/0187003 A1
(43) Pub. Date: Jul. 26, 2012

(54) SOFT ALARMING SAFER

(75) Inventors: Justin STEWART, Boca Raton, FL (US); Craig Roger SZKLANY, Lighthouse Point, FL (US); John C. FORD, Boca Raton, FL (US); John HESCH, JR., Orient, OH (US)

(73) Assignee: SENSORMATIC ELECTRONICS, LLC, Boca Raton, FL (US)

(21) Appl. No.: 13/011,356

(22) Filed: Jan. 21, 2011

(51) Int. Cl. G08B 21/00; B65D 77/00

(52) U.S. Cl. 206/216; 340/654

(57) ABSTRACT

A security device having a flexible material into which a product may be sealed and unauthorized removal of the product triggers a security alarm. The security device includes a flexible material adapted to house a product therein and is operable in a sealed orientation when the product is sealed within the flexible material and in an open orientation when the product is accessible from within the flexible material. Conductive material is affixed to the flexible material and forms a closed electrical circuit with an alarming device when the security device is in the sealed orientation and an open electrical circuit when the circuit is opened. The security alarm is triggered when the electrical circuit is opened.

### CROSS-REFERENCE TO RELATED APPLICATIONS

n/a

### STATEMENT REGARDING FEDERALLY SPONSORED RESEARCH OR DEVELOPMENT

n/a

### FIELD OF THE INVENTION

The present invention relates generally to security devices and more specifically to a security device made of flexible material.

### BACKGROUND OF THE INVENTION

Shoplifting continues to be a major concern of retail stores. Particularly with regard to electronic and other high-priced items, retailers continue to try and find effective product theft deterrents. However, wrongdoers are constantly coming up with methods of circumventing the latest theft-prevention devices offered by retailers. Consequently, retailers are coming up with new ways to protect goods from theft. For example, some retailers have introduced theft deterrent devices such as cables, also known as “spider wraps” that are wrapped around a product and that sound an alarm when there is an unauthorized attempt to remove the product from the wrap before it has been purchased. Other “safer” or “keeper” devices house the product but require at least some additional labor for their application and removal.

Each of these types of protection devices offer only limited sizes and shapes to conform to the many different sizes and shapes of products. Safers take up a great deal of space and spiders are only limited to box-shaped items. In addition, safers and spiders require a large amount of tooling and shipping containment. Some include alarms, some are more or less transparent, and some are even intended to be taken home with the customer along with their purchased product. There is also the option of using a hard tag coupled with a lanyard.

Many major retail store chains use rigid plastic electronic security keepers that provide electronic security protection for items such as ink cartridges, computer memory, and computer peripheral devices. These rigid keepers can be costly to build as they require complex injection molded tooling. Since the keepers are essentially rigid containers, many sizes are required for different size products. The keepers are intended to be used many times over for several years, but the polycarbonate material scratches and provides decreased visibility to the product contained within. Due to the high cost, the retailer may only purchase several sizes and, in many cases, not have the correct size available when needed. Consequently, retailers seek an easier solution by which they can effectively display their items for sale, prevent the unauthorized removal of items within the package, decrease in-store labor for the application and removal of these protective devices, and trigger an alarm as soon as the package seal is broken.

### SUMMARY OF THE INVENTION

The present invention advantageously provides a method and apparatus for securing different sized products in a flexible housing, where the housing includes conductive material and an alarming device. When the housing is opened without deactivation of the alarming device, a seal is broken and the electrical circuit formed by the conductive material and alarming device is opened, thus initiating activation of the alarming device. In this fashion, shoplifters attempting to remove the product from within the flexible housing will break the seal, opening the electrical circuit and activating the alarming device.

According to one aspect of the invention, a security device is provided where the security device includes a container formed of flexible material. The container is adapted to house a product therein and includes an inner surface and an outer surface. The security device also includes conductive material disposed on at least one of the inner surface and the outer surface of the container, the conductive material forming a closable electrical circuit.

According to another aspect of the invention, a security device is provided that includes a pouch for housing a product therein, the pouch having an inner surface and an outer surface, conductive material disposed on at least one of the inner surface and the outer surface of the pouch, and at least one conductive pad connected to the conductive material to form a closable electrical circuit. The conductive material further includes locations to removably receive an alarming device to close the electrical circuit.

According to yet another aspect of the invention, a security device is provided where the security device includes a foldable housing adapted to secure a product therein, the foldable housing having an interior surface and an exterior surface, conductive material affixed the interior surface of the foldable housing, the conductive material forming a closable electrical circuit, and an alarming device to close the electrical circuit. The alarming device is triggered when the electrical circuit is opened.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a front view of a soft alarming safer constructed in accordance with the principles of the present invention;

FIG. 2 is a front perspective view of an alternate embodiment of the soft alarming safer constructed in accordance with the principles of the present invention;

FIG. 3 is a front perspective view of the soft alarming safer device of FIG. 2 with a product being extracted from the safer device thereby activating an alarming device;

FIG. 4 is a front view of an alternate embodiment of the soft alarming safer device constructed in accordance with the principles of the present invention; and

FIG. 5 is a perspective view of the soft alarming safer device of FIG. 4 completely securing a product therein.

### DETAILED DESCRIPTION OF THE INVENTION

Before describing in detail exemplary embodiments that are in accordance with the present invention, it is noted that the embodiments reside primarily in combinations of apparatus components and processing steps related for providing a security device made of a flexible material into which a product may be sealed whereby unauthorized removal of the product triggers a security alarm.

Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” “internal” and “external”, “inside” and “outside”, and the like, may be used solely to distinguish one entity or element from another entity or element without necessarily requiring or implying any physical or logical relationship or order between such entities or elements.

One embodiment of the present invention advantageously provides a security device for housing a product, where the security device is made of flexible material to house the product and also includes conductive material disposed along the flexible material where the conductive material forms a closed electrical circuit. When there is an unauthorized attempt to remove the product from the flexible material during, for example, a shoplifting attempt, the electrical circuit is opened and an alarming device triggered.

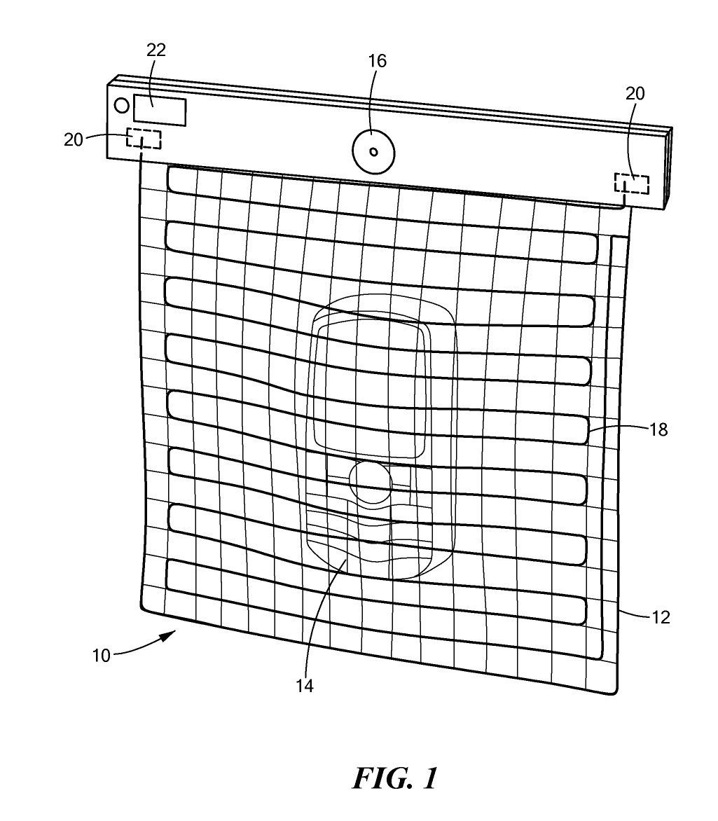

Referring now to the drawing figures in which like reference designators refer to like elements, there is shown in FIG. 1 an exemplary configuration of a product protection safer/keeper apparatus 10 according to an embodiment of the present invention. Apparatus 10 is a security device that includes a container, e.g., pouch 12, made of flexible material. Pouch 12 can be substantially transparent to enable shoppers to view product 14 contained within pouch 12. Pouch 12 can be made of plastic, e.g., polycarbonate, or other types of flexible material such as paper, cloth or TYVEK, sized to house different sized and shaped products. Small products such as, for example, batteries of cellular telephones can be housed in the same sized pouch as larger products such as DVD players or toasters. Thus, one sized pouch 12 can be kept in stock by retailers and can be used for a wide range of products within the store.

Pouch 12 can operate in a locked or sealed orientation where product 14 is not accessible to customers. Lock 16 can secure a fold-down tab 16 to pouch 12 and thereby prevent unwanted entry into pouch 12. Lock 16 can be a magnetic lock similar to the type used in hard tags which can be opened using existing detachers. Pouch 12 includes conductive material 18, such as a conductive ink, which is formed from a series of interlocking electrical conductors forming a grid. The grid serves as an “electric fence” to ward off customers who may wish to remove product 14 from within 12 without paying for the product 14. Conductive material 18 can be transparent or virtually transparent so that customers cannot see the conductive material 18 and believe that pouch 12 is a simple product storage bag instead of an alarmed security device. Conductive material 18 can be a serial conductive trace around the perimeter and along the surface of pouch 12. Conductive material 18 can include a single, serial electrical trace or include multiple traces. Alternately, pouch 12 can include a visible ink pattern, for example, the visible cross-hatched pattern as shown in FIG. 1. Superimposed on the visible cross-hatched ink pattern is a non-visible random pattern of electrical conductors. A random pattern of conductors poses a difficulty for would-be shoplifters who suspect that there may be an electrical conductive grid on pouch 12.

Conductive pads 20 are connected to the electrical conductors of conductive material 18. If a customer somehow removes or breaks lock 16 and then attempts to remove product 14 by lifting fold-down tab 16, the electrical conductors break their connection with one or both of conductive pads 20 forming an open electrical circuit. This can trigger an alarming device 22, which can be situated anywhere on security device 10 provided it is in electrical communication with conductive pads 20. Thus, when product 14 is being inserted into pouch 12 by a salesperson, alarming device 22 is not activated. After product 14 is inserted within pouch 12, alarming device 22 is activated and can only be deactivated when the product has been legitimately purchased at a point of sale (“POS”) or when an employee of the retail store wants to gain access to within pouch 12 such as, for example, to replace product 14 with a different product, perhaps a product that is on sale.

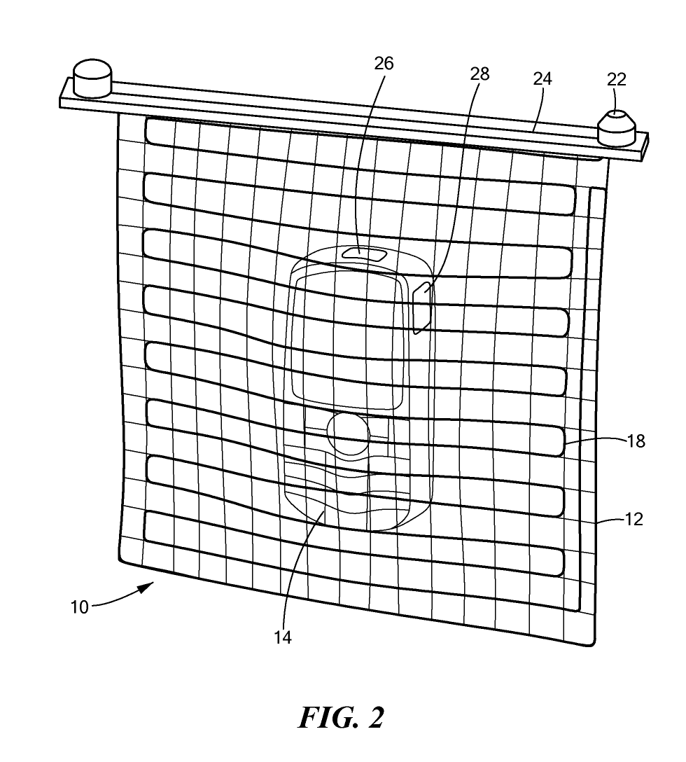

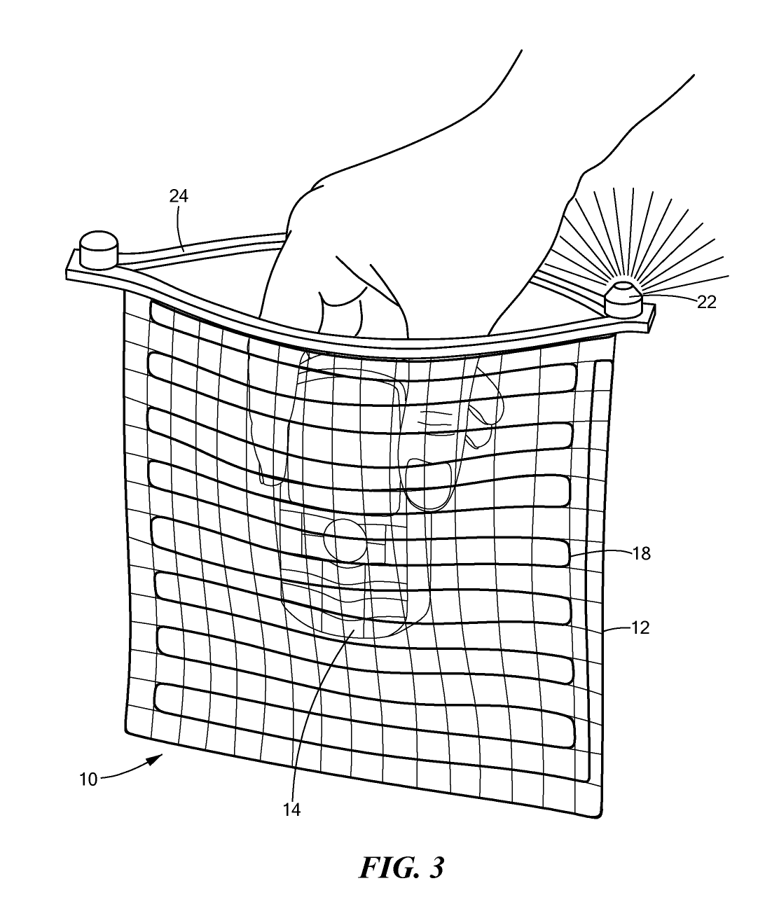

FIG. 2 shows an alternate embodiment of the present invention. In FIG. 2, pouch 12 includes conductive material 18 and houses product 14 therein. Seal 24 is configurable between an open and a closed configuration. When seal 24 is closed, alarming device 22 is not triggered as the electrical grid of conductors forming conductive material 18 forms a closed electrical circuit. FIG. 3 illustrates security device 10 with seal in an open configuration. When seal 24 is opened, for example, by a shoplifter trying to gain access to product 14, the electrical circuit forming conductive material 18 is broken. The break in the electrical circuit can be detected by a microcontroller that detects breaks anywhere in the electrical grid or can be detected by measuring the overall impedance of the grid. Alternately, glue that is used to secure the electrical traces of the grid to pouch 12 will lift and break when seal 24 is opened thus separating the trace from pouch 12. This causes an open circuit which will trigger alarming device 22.

Product 14 can also include an EAS tag or label 26. By affixing EAS tag 26 on product 14, opening pouch 12 to remove product 14 from within apparatus 10 without deactivation of the label 26 will trigger alarming device 22. Similarly, security device 10 can include an RFID element such as a sensor 28. Inclusion of RFID sensor 28 can provide real-time information to a store owner about the identity of product 14 contained within pouch 12.

FIG. 3 shows pouch 12 with product 14 contained therein, in an open configuration. Seal 24 is opened to allow for product 14 to be extracted. Instead of seal 24, other product securing mechanisms can be used such as a zipper, buttons, or a drawstring. As described above, when seal 24 is opened, alarming device 22 will be triggered unless security device 10 has been previously deactivated. As described above, triggering the alarm when alarming device 22 is active can occur in a number of ways. For example, a break in the electrical circuit that forms the electrical grid of conductive material 18 can be detected by a microcontroller that detects breaks anywhere in the electrical grid. Or, glue that is used to secure the electrical traces of the grid to pouch 12 will lift and break when seal 24 is opened thus separating the trace from pouch 12 and causing a break in the circuit. In either instance, an open electrical circuit in conductive material 18 is detected, and upon detection, alarming device 22 is triggered, warning others that seal 24 was broken. Of note, although FIGS. 1-3 show conductive material 18 on a single side of pouch 12, this arrangement is used purely for ease of depiction and explanation. It is understood that conductive material 18 is present on both sides of pouch 12 such that an interruption of the conductive material 18 on either side, e.g., by tearing the pouch 12, would trigger an alarm.

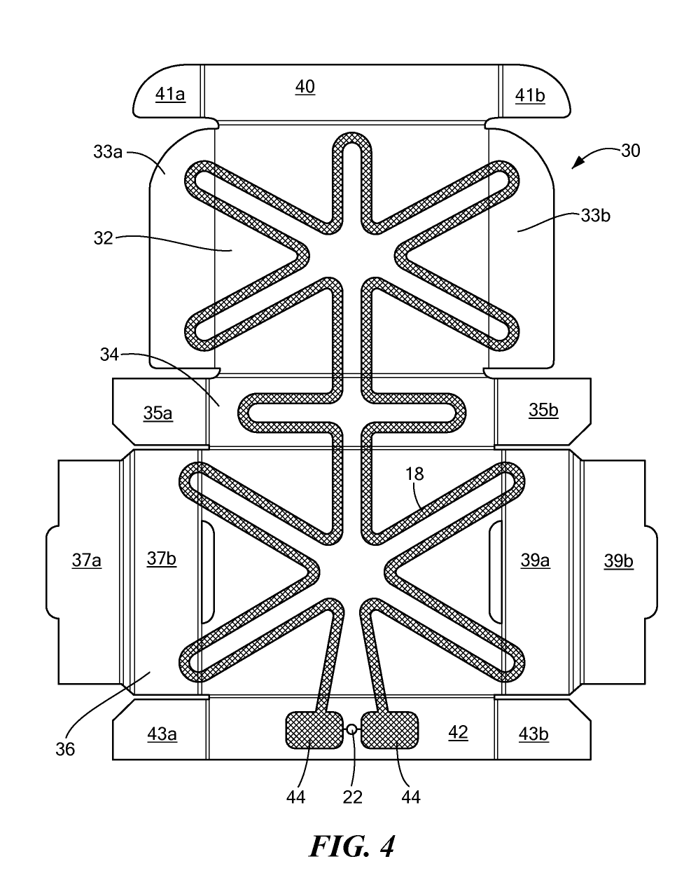

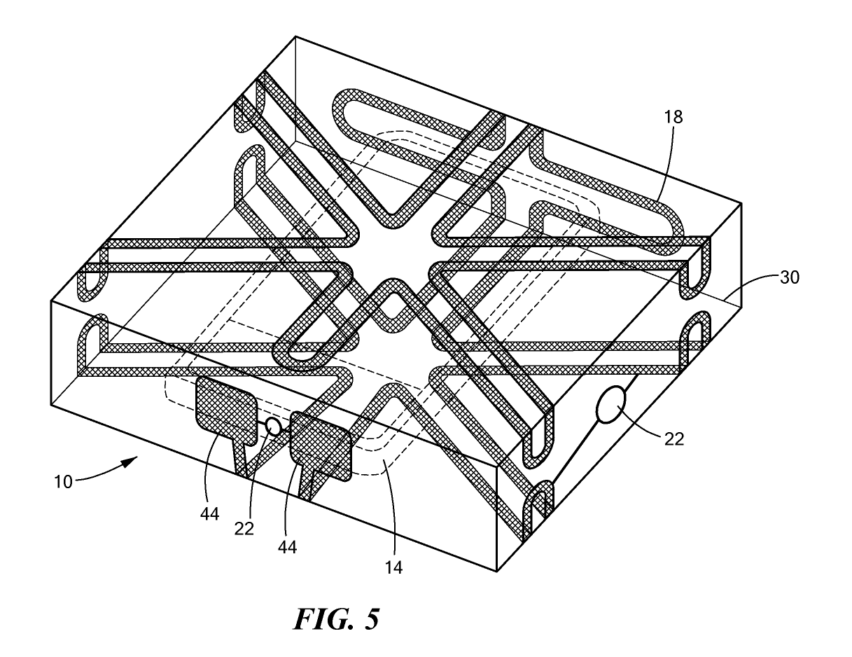

FIGS. 4 and 5 illustrate yet another embodiment of the present invention. A plastic film folding carton 30 is used to house product 14. Carton 30 can be made inexpensively due to minimal tooling costs and low film material costs. Plastic films such as Polyvinyl chloride, (“PVC”) and Amorphous Polyethylene Terephthalateare (“APET”) can be used to form carton 30 although other materials are also contemplated. Materials such as PVC and APET are robust and can adequately provide security protection for items that require an anti-shoplifting solution. Cartons 30 can be reused numerous times with reasonable handling. Cartons 30 can also be shipped flat to the customer, e.g., retailer. After use, carton 30 can be unassembled and stored in a flat condition until used again. Cartons 30 can also be sent home with the purchaser of an item within the carton 30.

FIG. 4 shows carton 30 in a flat orientation. In one embodiment, carton 30 includes upper panel 32 having left upper tab 33a and right upper tab 33b, middle panel 34 having left middle tab 35a and right middle panel 35b, and bottom panel 36 having left bottom tabs 37a and 37b and right bottom tabs 39a and 39b. Carton 30 also includes outer front panel 40 having outer tabs 41a and 41b, and inner front panel 42 having inner tabs 43a and 43b.

Carton 30 can be die-cut and prepared as using industry standard folding carton technology. The design of folding carton 30 can vary according to the style required for specific customer needs. The embodiment shown in FIG. 4 is a tuck-folder type of carton 30. Other types of designs for carton 30 are also contemplated including rectangular and oval tubes with a mating end cap. The film that forms carton 30 can be clear, opaque, or of various colors. The film can also include customized graphics to indicate specific security warnings, or store logo identification markings, etc. The film can also be constructed of laminates such as a combination of APET/PE if additional features or processes are required such as heat sealing or vacuum forming.

Continuing to refer to FIG. 4, conductive material 18 is formed, integrated, or placed on the inner surface of carton 30. Conductive material 18 creates an electronic path that forms an electrical circuit. If the conductive path is cut or broken, which may occur in an attempt to defeat or penetrate carton 30, an audible, visible or audible and visible alarm will be triggered via alarming device 22 (not shown) which can be removably attached to leads 44 on inner front panel 42, as shown in FIG. 4. Conductive material 18 can be made of conductive ink, aluminum, or copper based material. In one embodiment, conductive material 18 can be permanently adhered to the inner surface of the plastic film surface of carton 30. A protective conformal coating or laminate may also be used to cover and electrically insulate conductive material 18 from product 14 (not shown) contained within folded carton 30 to eliminate the potential for a short circuit. Conductive material 18 can be made to be as discrete as possible when viewed from the carton exterior unless specific customer requirements call for a noticeably visible warning of an electronically protected package.

FIG. 5 shows product 14 contained within carton 30. With carton 30 folded and closed, such that panels 40 and 42 are folded adjacent to each other, alarming device 22 securely attaches to and locks carton 30 closed via relief or access holes located strategically in panels 40 and 42 (not shown). Electrical contact mechanisms within alarming device 22 protrude through panels 40 and 42 and connect to leads 44, thus creating a protective conductive circuit. Also, although alarming device 22 can be attached to carton 30 at leads 44, the invention is not limited to such. For example, FIG. 5 shows a second alarming device 22 coupled to conductive material 18 at a point other than at leads 44. This alarming device can be supplemental to or in lieu of the alarming device 22 affixed to leads 44. The arrangement of the conductive pattern of conductive material 18 need not appear a shown in FIG. 4 and may form any pattern along the inner surface of carton 30. However, by providing a pattern having conductive portions on the top panel 32, middle panel 34 and bottom panel 36, it is more likely that a shoplifter opening any of the tabs show in FIG. 4 will trigger alarming device 22. Once folded into a carton configuration, conductive material 18 is provided on all sides of carton 30 in such a manner that any attempted penetration of carton 30 that will be large enough to remove item 14 will cut conductive material 18, thereby activating alarming device 22.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A security device comprising:
a container formed of flexible material, the container adapted to house a product therein, the container having an inner surface and an outer surface; and
conductive material disposed on at least one of the inner surface and the outer surface of the container, the conductive material forming a closeable electrical circuit.

2. The security device of claim 1, the container further comprising an alarming device removably affixed thereto, the alarming device closing the electrical circuit and being triggered when the electrical circuit is opened.

3. The security device of claim 2, wherein the alarming device emits an audible alarm signal.

4. The security device of claim 2, wherein the alarming device emits a visual alarm signal.

5. The security device of claim 2, further comprising an unlocking mechanism to allow the product to be removed from within the flexible material without triggering the alarming device.

6. The security device of claim 2, the product including an electronic article surveillance (EAS) label affixed thereto, wherein the alarming device is triggered upon receipt by the EAS label of an EAS interrogation signal.

7. The security device of claim 1, further comprising a radio frequency identification (RFID) element.

8. The security device of claim 1, further comprising a locking mechanism to secure the product within the flexible material.

9. The security device of claim 1, wherein the flexible material is a foldable carton sized to house the product.

10. The security device of claim 9, wherein the conductive material is disposed on the inner surface of the carton.

11. The security device of claim 10, the carton further including a laminate disposed over the conductive material to prevent contact between the conductive material and the product.

12. The security device of claim 1, the conductive material comprising a random pattern of electrical conductors disposed on the outer surface of the flexible material.

13. The security device of claim 12, wherein the random pattern of conductors is not visible.

14. The security device of claim 13, wherein the flexible material further includes a visible pattern of non-conductive electrical traces, wherein the random pattern of conductors is superimposed within the visual pattern of non-conductive electrical traces.

15. A security device comprising:
a pouch for housing a product therein, the pouch having an inner surface and an outer surface;
conductive material disposed on at least one of the inner surface and the outer surface of the pouch;
at least one conductive pad connected to the conductive material to form a closable electrical circuit, the conductive material further including locations to removably receive an alarming device.

16. The security device of claim 15, further comprising a locking device for sealing the pouch containing the product.

17. The security device of claim 15, wherein the alarming device triggered when the electrical circuit is open.

18. A security device comprising:
a foldable housing adapted to secure a product therein, the foldable housing having an interior surface and an exterior surface;
conductive material affixed the interior surface of the foldable housing, the conductive material forming a closable electrical circuit; and
an alarming device, the alarming device closing the electrical circuit and being triggered when the electrical circuit is opened.

19. The security device of claim 18, the product including an electronic article surveillance (EAS) label affixed thereto, wherein the alarming device is triggered upon receipt by the EAS label of an EAS interrogation signal.

20. The security device of claim 18, further comprising a radio frequency identification (RFID) element.
